(19) United States
(12) Patent Application Publication
(10) Pub. No.: US 2025/0196098 A1
(43) Pub. Date: Jun. 19, 2025

(54) ADSORPTION APPARATUS AND METHOD OF MANUFACTURING ADSORPTION APPARATUS

(71) Applicant: HOYA TECHNOSURGICAL CORPORATION, Tokyo (JP)

(72) Inventor: Tomohiko YOSHITAKE, Tokyo (JP)

(73) Assignee: HOYA TECHNOSURGICAL CORPORATION, Tokyo (JP)

(21) Appl. No.: 18/843,105

(22) PCT Filed: Mar. 11, 2022
(86) PCT No.: PCT/JP2022/010909

§ 371 Date: Aug. 30, 2024

(51) Int. Cl. B01J 20/28; B01D 15/22; B01D 15/38

(52) U.S. Cl. CPC B01J 20/28004; B01D 15/22; B01D 15/3847; B01J 20/28052

(57) ABSTRACT

Object: To provide an adsorption apparatus having improved separation performance by securely suppressing or preventing non-uniformity in particle size distribution within a column of a powder of hydroxyapatite charged in a column, and a method of manufacturing an adsorption apparatus by which the adsorption apparatus can be manufactured. Resolution means: An adsorption apparatus of the present invention includes: a column main body that is tubular and includes an adsorbent filling space therein; a first port provided at one end of the column main body and having a first flow path through which liquid flows; a second port provided at the other end of the column main body and having a second flow path through which liquid flows; and an adsorbent that is charged in the adsorbent filling space, wherein the adsorbent contains a powder, and 0.72≤A1/A3≤1.38 is satisfied, where a modal particle size in a particle size distribution of the powder present in a first region, which is one end of the adsorbent filling space, is A1 [μm], and a modal particle size in a particle size distribution of the powder present in a third region, which is the other end of the adsorbent filling space, is A3 [μm].

### TECHNICAL FIELD

The present invention relates to an adsorption apparatus having improved separation performance, and an adsorption apparatus manufacturing method an for manufacturing the adsorption apparatus.

### BACKGROUND ART

In recent years, hydroxyapatite, because of its high biocompatibility and excellent safety for example, has been widely used as a material for stationary phase of chromatography, i.e., an adsorbent, for use in purification and isolation of bio-based pharmaceuticals such as antibodies and vaccines.

An adsorption apparatus including, as an adsorbent, a powder of hydroxyapatite (HAP) used as a material for stationary phase of chromatography is manufactured, for example, by applying a manufacturing method described below.

Specifically, a first liquid containing calcium hydroxide and a second liquid containing phosphoric acid are reacted under stirring to obtain primary particles of hydroxyapatite, a slurry containing the primary particles and agglomerates thereof is dried and granulated, thereby obtaining secondary particles of hydroxyapatite.

A green powder formed from particles containing the secondary particles is baked (sintered) to obtain a sintered powder.

Next, the green powder or sintered powder of hydroxyapatite is charged into an adsorbent filling space included in a column main body or the like of a column, so that an adsorption apparatus is manufactured in which the green powder or sintered powder is provided as a material for stationary phase (adsorbent) (see, for example, Patent Document 1).

However, in the method of manufacturing an adsorption apparatus as described above, the green powder or sintered powder of hydroxyapatite, as the adsorbent 3, is charged into the adsorbent filling space 20 included in the column main body 21 as will be described below.

Specifically, as shown in FIG. 7, a column passage section 221 included in an extension column 200 is connected to the column main body 21 included in a column 2. In a column connection body 250 in which the column main body 21 and the column passage section 221 are connected to each other, the slurry containing the adsorbent 3 is supplied to an adsorbent passage space 220 of the column passage section 221 from an upper end of the column passage section 221, in a state in which the column main body 21 is located vertically below and the column passage section 221 is located vertically above.

Then, while maintaining the state in which the column main body 21 is located vertically below and the column passage section 221 is located vertically above, a filling solution 66, such as water, is pressurized and supplied from the upper end of the column passage section 221 using a pump 60, so that the filling solution 66 is passed through the extension column 200 and the column 2 from the upper side toward the lower side.

Due to the passage of the filling solution 66 through the extension column 200 and the column 2 from the upper side toward the lower side and, further, due to gravity exerted on the adsorbent 3, the adsorbent 3 contained in the slurry is sequentially precipitated in the adsorbent passage space 220 of the column passage section 221 and the adsorbent filling space 20 of the column main body 21, so that the adsorbent 3 is charged in the adsorbent filling space 20 included in the column main body 21.

Here, since the secondary particles of hydroxyapatite are obtained by granulating the primary particles and the agglomerates thereof, as described above, the powder (green powder or sintered powder) of hydroxyapatite as the adsorbent 3 has a relatively large particle size distribution.

Therefore, when the adsorbent 3 is precipitated in the adsorbent passage space 220 included in the column passage section 221 and the adsorbent filling space 20 included in the column main body 21 so that the adsorbent 3 is charged in the adsorbent filling space 20 included in the column main body 21, the adsorbent 3 having a large particle size is unevenly distributed on the lower side of the column 2, and the adsorbent 3 having a small particle size is unevenly distributed on the upper side of the column 2. That is, non-uniformity in particle size distribution of the adsorbent 3 in the column 2 occurred. Therefore, the non-uniformity in particle size distribution causes a problem that the column performance of purifying and isolating the biopharmaceuticals as substance to be adsorbed cannot be imparted to an adsorption apparatus that includes the adsorbent 3, or that the durability of the adsorbent 3 will be deteriorated. The present inventors have found the presence of such problems.

### CITATION LIST

### Patent Literature

PTL 1: Patent Document 1: JP 2011-68539 A

### SUMMARY OF INVENTION

### Technical Problem

An object of the present invention is to provide an adsorption apparatus having improved separation performance and a method of manufacturing an adsorption apparatus by which the adsorption apparatus can be manufactured.

### Solution to Problem

The object is achieved by the present invention described in (1) to (11) below.

(1) An adsorption apparatus including:
a column main body that is tubular and includes an adsorbent filling space therein;
a first port provided at one end of the column main body and having a first flow path through which liquid flows;
a second port provided at the other end of the column main body and having a second flow path through which liquid flows; and
an adsorbent that is charged in the adsorbent filling space,
wherein
the adsorbent contains a powder formed from aggregates of fine particles having a non-constant particle size, and
0.72≤A1/A3≤1.38 is satisfied, where a modal particle size in a particle size distribution of the powder present in a first region, which is one end of the adsorbent filling space, is A1 [μm], and a modal particle size in a particle size distribution of the powder present in a third region, which is the other end of the adsorbent filling space, is A3 [μm].

As described above, A1/A3, as a parameter representing the uniformity of the modal particle sizes A1 and A3 of the adsorbent present in the first region and the third region, which are both ends of the adsorbent filling space, satisfies the relationship 0.72≤A1/A3≤1.38. In other words, a lower limit value of A1/A3 is 0.72. An upper limit value of A1/A3 is 1.38. Therefore, it can be said that the adsorbent is charged in the adsorbent filling space with a substantially uniform particle size distribution, and the column performance of purifying and isolating substances to be adsorbed can be reliably imparted to an adsorption apparatus that includes the adsorbent. Furthermore, excellent durability can be imparted to the adsorbent included in the column.

(2) The adsorption apparatus according to (1), wherein the powder adsorbs a substance to be adsorbed when a sample solution containing the substance is supplied a substance to be adsorbed to the adsorbent filling space via the first flow path of the first lid in a state in which the first lid is located vertically above the second lid.

The adsorption apparatus of the present invention is suitably applied to an adsorption apparatus having such a configuration.

(3) The adsorption apparatus according to (2), wherein 0.72≤A1/A2≤1.38 is satisfied, where a modal particle size in a particle size distribution of the powder in a second region located at a midpoint between the one end and the other end is A2 [μm].

As a result, it can be said that the adsorbent is charged in the adsorbent filling space with a more uniform particle size distribution.

(4) The adsorption apparatus according to (3), wherein 0.80≤B1/B2≤1.15 is satisfied, where a frequency of the modal particle size in the particle size distribution of the powder in the second region is B2(%).

As a result, it can be said that the adsorbent is charged in the adsorbent filling space with a more uniform particle size distribution.

(5) A method of manufacturing an adsorption apparatus, including:
a first step of preparing a column including: a column main body that is tubular and has an adsorbent filling space therein; a first port provided at one end of the column main body and having a first flow path through which liquid flows; and a second port provided at the other end of the column main body and having a second flow path through which liquid flows;
a second step of charging a composition including an adsorbent containing a powder formed from aggregates of fine particles having a non-constant particle size and a first liquid into the adsorbent filling space of the column; and
a third step of supplying a second liquid to the adsorbent filling space via the first flow path of the first port in a state in which the first port side of the column is located vertically below.

According to the method of manufacturing an adsorption apparatus of the present invention, the adsorbent can be charged, with a substantially uniform particle size distribution, in the adsorbent filling space included in the column main body.

(6) The method of manufacturing an adsorption apparatus according to (5), further including, prior to the second step,
a step of preparing an extension column including: a column passage section that is tubular and has an adsorbent passage space therein; a cover body provided at one end of the column passage section and having a third flow path through which liquid flows; and a connection section provided at the other end of the column passage section and connectable to the one end side of the column main body; and
a step of connecting, via the connection section, the other end of the column passage section to the one end of the column main body in a state in which the first port is disengaged.

As a result, the adsorbent can be charged, with a substantially uniform particle size distribution, in the adsorbent filling space included in the column main body.

(7) The method of manufacturing an adsorption apparatus according to (5) or (6), wherein the adsorption apparatus obtained through the third step satisfies 0.72≤A1/A3≤1.38, where a modal particle size in a particle size distribution of the powder present in a region at one end of the adsorbent filling space is A1 [μm], and a modal particle size in a particle size distribution of the powder present in a region at the other end of the adsorbent filling space is A3 [μm].

According to the method of manufacturing an adsorption apparatus of the present invention, the adsorbent can be charged, with a substantially uniform particle size distribution, in the adsorbent filling space included in the column main body, and, specifically, the modal particle sizes A1, A3 can satisfy the relationship 0.72≤A1/A3≤1.38. In other words, a lower limit value of A1/A3 is 0.72. An upper limit value of A1/A3 is 1.38.

### Advantageous Effects of Invention

The adsorption apparatus of the present invention has improved separation performance. The manufacturing method of the present invention is capable of manufacturing the adsorption apparatus.

### BRIEF DESCRIPTION OF DRAWINGS

FIG. 1 is a vertical cross-sectional view illustrating an example of an adsorption apparatus of an embodiment of the present invention.

FIG. 2 is a flowchart illustrating a method of manufacturing an adsorption apparatus of an embodiment of the present invention.

FIG. 3 is a vertical cross-sectional view for describing the method of manufacturing an adsorption apparatus of an embodiment of the present invention.

FIG. 4 is a vertical cross-sectional view for describing the method of manufacturing an adsorption apparatus of an embodiment of the present invention.

FIG. 5 is a vertical cross-sectional view for describing the method of manufacturing an adsorption apparatus of an embodiment of the present invention.

FIG. 6 is a graph showing a particle size distribution of an adsorbent which was present at a position corresponding to the first region in an adsorption apparatus of Example 1.

FIG. 7 is a vertical cross-sectional view for describing a method of manufacturing a known adsorption apparatus.

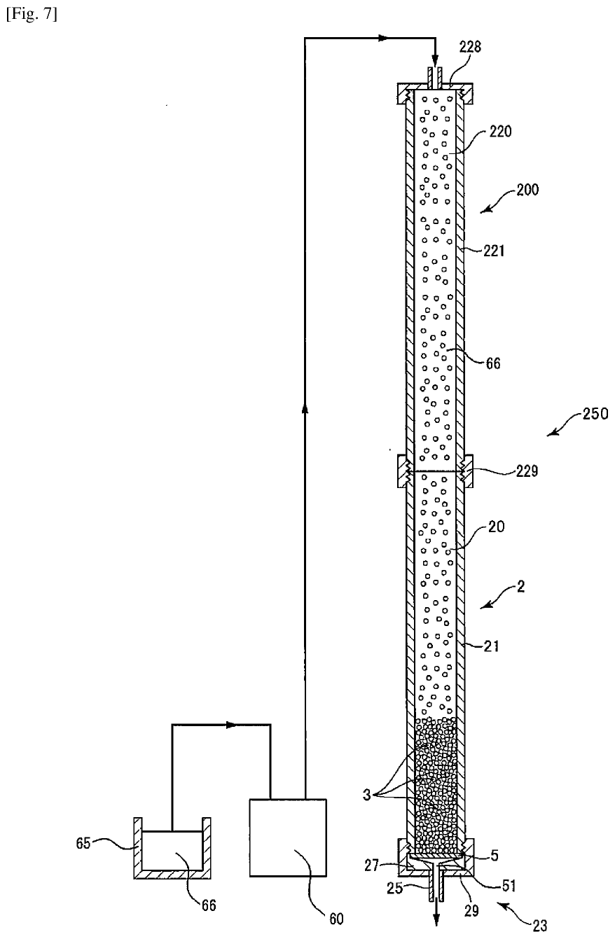

### DESCRIPTION OF EMBODIMENTS

An adsorption apparatus and a method of manufacturing an adsorption apparatus according to the present invention will be described below in detail based on preferred embodiments illustrated in the accompanying drawings.

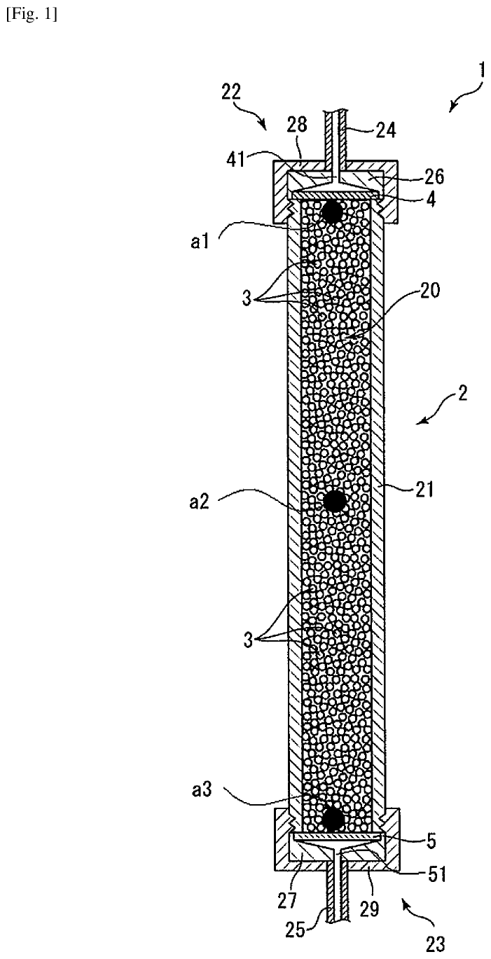

FIG. 1 is a vertical cross-sectional view illustrating an example of an adsorption apparatus of an embodiment of the present invention. Note that, in the following description, the upper side in FIG. 1 is referred to as “inflow side” and the lower side is referred to as “outflow side”.

Here, the “inflow side” refers to a side where, for example, a liquid such as a sample solution (a liquid containing a substance to be adsorbed) or an eluate (such as a phosphoric acid-based buffer solution or water) is supplied into the adsorption apparatus, whereas the “outflow side” refers to a side opposite the inflow side, that is, a side where the liquid flows out of the adsorption apparatus, when the substance to be adsorbed, as an isolation material such as a biopharmaceutical, i.e., a protein to be separated is separated (purified).

An adsorption apparatus 1, as illustrated in FIG. 1, which separates (purifies) an isolation material such as a protein from a sample solution includes a column 2, a granular adsorbent (filler) 3, and two filter members 4 and 5.

The column 2 includes a column main body 21 and a cover portion 22 (first port) and a cover portion 23 (second port) attached to an inflow side end and an outflow side end of the column main body 21, respectively.

The column main body 21 is composed of a cylindrical member, for example. Examples of constituent materials of each component (each member) constituting the column 2 including the column main body 21 include various glass materials, various resin materials, various metal materials, and various ceramic materials.

In the column main body 21, the cover portions 22 and 23 are attached to the inflow side end and the outflow side end thereof, respectively, in a state in which the filter members 4 and 5 are disposed so as to close an inflow side opening and an outflow side opening of the column main body 21, respectively.

In the column 2 having such a configuration, the column main body 21 and the filter members 4 and 5 define an adsorbent filling space 20. Additionally, the column main body 21 and the cover portions 22 and 23 ensure liquid tightness of the adsorbent filling space 20. The adsorbent 3 is charged into at least part (substantially a full volume, in the present embodiment) of the adsorbent filling space 20.

An inner diameter of the adsorbent filling space 20 (column inner diameter) is set appropriately in accordance with a volume of a sample solution, and is not particularly limited, but is preferably approximately 3.0 mm or greater and 70.0 mm or less, and more preferably approximately 5.0 mm or greater and 50.0 mm or less. In addition, a length of the adsorbent filling space 20 (column length) is, for example, preferably approximately 10.0 mm or greater and 300.0 mm or less, and more preferably approximately 20.0 mm or greater and 200.0 mm or less. By using the column 2 having such dimensions (inner diameter and length) of the adsorbent filling space 20 to isolate the isolation material contained in the sample solution, the isolation material can be purified with excellent precision.

By setting the dimensions of the adsorbent filling space 20 to the values as described above and setting the dimensions of the adsorbent 3 described later to values as will be described below, it is possible to selectively isolate (purify) the target material to be isolated from the sample solution, that is, to reliably separate an isolation material (substance to be adsorbed) such as a protein and contamination substances other than the isolation material contained in the sample solution from each other.

Note that the isolation material to be isolated (purified) using the adsorbent 3 is not limited to proteins such as albumin, acidic proteins such as antibodies, and basic proteins, and that examples thereof include negatively charged substances such as acidic amino acids, DNA, RNA, and negatively charged liposomes; and positively charged substances such as basic amino acids, positively charged cholesterol, and positively charged liposomes. That is, various substances including bio-based pharmaceuticals such as antibodies and vaccines can be purified and isolated, as substances to be adsorbed, using the adsorbent 3.

Further, the cover portions 22 and 23 are attached to the column main body 21 to ensure liquid tightness therebetween.

The cover portion 22 (first port) and the cover portion 23 (second port) include a cap 28 and a cap 29, an inlet pipe 24 (first flow path) and an outlet pipe 25 (second flow path), and a lid 26 and a lid 27, respectively.

The caps 28 and 29 are attached by screwing to the inflow side end (one end) and the outflow side end (the other end) of the column main body 21, with the inflow side end of the column main body 21 being located vertically above and the outflow side end being located vertically below. Each of the caps 28 and 29 and the column main body 21 ensure liquid tightness therebetween.

The inlet pipe 24 and the outlet pipe 25 are composed of a tube body through which the liquid flows, and are adhered (fixed) liquid-tightly to substantially centers of the caps 28 and 29, respectively. The lids 26 and 27 include flow paths 41 and 51, respectively, disposed between the filter members 4 and 5 and the caps 28 and 29 and communicating with the inlet pipe 24 and the outlet pipe 25. The liquid is supplied to the adsorbent 3 via the inlet pipe 24, the lid 26, and the filter member 4. The sample solution supplied to the adsorbent 3 passes between the adsorbents 3 (gap) and flows out of the column 2 via the filter member 5, the lid 27, and the outlet pipe 25. At this time, the isolation material (substance to be adsorbed) and the contamination substances other than the isolation material, contained in the sample solution (sample), are separated from each other based on a difference in adsorbability to the adsorbent 3 and a difference in affinity for the eluate.

In other words, in a state in which the cover portion 22 is located vertically above the cover portion 23, the adsorption apparatus 1 supplies the liquid to the adsorbent filling space 20 via the inlet pipe 24, adsorbs the isolation material by the adsorbent 3 charged in the adsorbent filling space 20, and uses the adsorption of this isolation material to separate the isolation material.

Each of the filter members 4 and 5 has a function of preventing the adsorbent 3 from flowing out of the adsorbent filling space 20, that is, a function of retaining the adsorbent 3 within the adsorbent filling space 20. These filter members 4 and 5 are each composed of, for example, a polypropylene mesh, a sintered filter of polyethylene particles, a stainless mesh filter, or a sintered filter of stainless particles.

In the adsorption apparatus 1, the adsorbent 3 includes a powder formed from aggregates of fine particles having a non-constant particle size, and has adsorption capability to the isolation material (substance to be adsorbed) contained in the sample solution (sample), and is preferably composed of a green powder formed from particles containing secondary particles of hydroxyapatite or a sintered powder thereof. Note that, in the present specification, the green powder and sintered powder of hydroxyapatite are collectively referred to as “powder of hydroxyapatite”. Therefore, a description is given below as an example of a case in which the powder of hydroxyapatite is charged in the adsorbent filling space 20 of the column main body 21 as the adsorbent 3.

In the present invention, the adsorbent 3 satisfies the relationship 0.72≤A1/A3≤1.38, when a modal particle size in a particle size distribution of the adsorbent 3 present in a first region a1 in the adsorbent filling space 20 of the adsorption apparatus 1 is A1 [μm], and a modal particle size in a particle size distribution of the adsorbent 3 present in a third region a3 in the adsorbent filling space 20 of the adsorption apparatus 1 is A3 [μm], but the adsorption apparatus 1 satisfying the relationship is obtained by applying a method of manufacturing an adsorption apparatus which will be described below, and thus a description of this relationship will be given later.

Note that, in the present embodiment, the adsorbent 3 that is charged in the adsorbent filling space 20 of the adsorption apparatus 1 of an embodiment of the present invention is a powder of hydroxyapatite, but the adsorbent 3 contains a powder formed from aggregates of fine particles having a non-constant particle size. In a preferred embodiment of the present invention, the aggregates of fine particles preferably has a predetermined modal particle size (modal diameter) and has a peak particle size distribution centered on a value of the modal particle size. In another preferred embodiment of the present invention, the aggregates of fine particles preferably has a particle size distributed above and below the value of the modal particle size such that an appearance frequency is lower away from the value of the modal particle size.

In addition to the powder of hydroxyapatite shown in the present embodiment, the powder constituting the adsorbent 3 charged in the adsorbent filling space 20 of the adsorption apparatus 1 according to an embodiment of the present invention may be a powder of an inorganic compound such as silica, fluoroapatite, calcium pyrophosphate, magnesium pyrophosphate, alumina, or zirconia, may be a powder of an organic compound such as a polymer bead, or may be a polymer such as sepharose or agarose, or a mixture thereof. The effect of the present invention is better when a product containing a powder formed from aggregates of fine particles having a non-constant particle size is used as the adsorbent 3.

The powder of hydroxyapatite may be a commercially available product. The powder of hydroxyapatite may be, for example, CHT (trade name in the U.S.) Type I, CHT (trade name in the U.S.) Type II, or CHT (trade name in the U.S.) XT, or MPC or CFT, available from Bio-Rad Laboratories.

When manufacturing the powder of hydroxyapatite, the powder of hydroxyapatite can be manufactured according to the methods described in, for example, the specifications of JP 7-88205 B and JP 5724050≤B2. Specifically, to manufacture powder of hydroxyapatite, a manufacturing method can be performed which includes a step [S1A] of reacting a first liquid containing a calcium source such as calcium hydroxide and a second liquid containing a phosphoric source such as phosphoric acid under stirring to obtain a slurry containing primary particles of hydroxyapatite and agglomerates thereof; a step [S2A] of physically pulverizing the agglomerates contained in the slurry and dispersing the pulverized agglomerates in the slurry; and a step [S3A] of drying the slurry and granulating the pulverized agglomerates, thereby obtaining a powder composed of particles containing mainly secondary particles of hydroxyapatite.

The powder constituting the adsorbent 3 charged in the adsorbent filling space 20 of the adsorption apparatus 1 of an embodiment of the present invention may be a green powder or a sintered powder. The powder constituting the adsorbent 3 charged in the adsorbent filling space 20 of the adsorption apparatus 1 of an embodiment of the present invention may be classified or may not be classified. When the powder is not classified, the powder has a wider particle size distribution, and therefore, the effect according to the present invention can be more significantly exhibited.

When the powder constituting the adsorbent 3 charged in the adsorbent filling space 20 of the adsorption apparatus 1 of an embodiment of the present invention is classified, it may have an average particle size and a particle size distribution such as a particle size of 20±4 μm, a particle size of 40±4 μm, a particle size of 60±4 μm, and a particle size of 80±4 μm.

The adsorption apparatus 1 is obtained by charging the powder described above, as the adsorbent 3 (material for stationary phase), in the adsorbent filling space 20 of the column main body 21. When the adsorbent 3 is charged in the adsorbent filling space 20, the method of manufacturing an adsorption apparatus of an embodiment of the present invention is applied.

A method of manufacturing the adsorption apparatus 1 to which the method of manufacturing an adsorption apparatus of an embodiment of the present invention is applied will be described below.

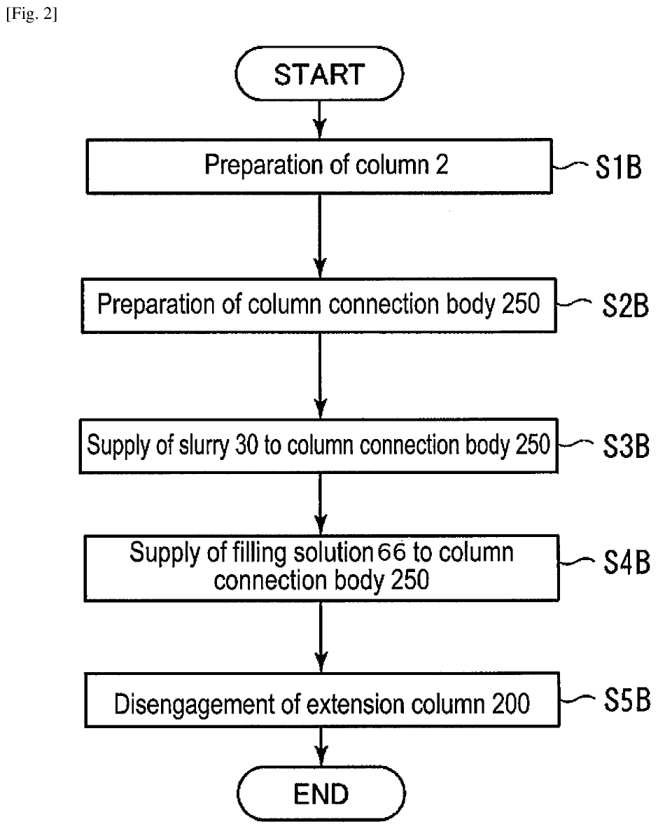

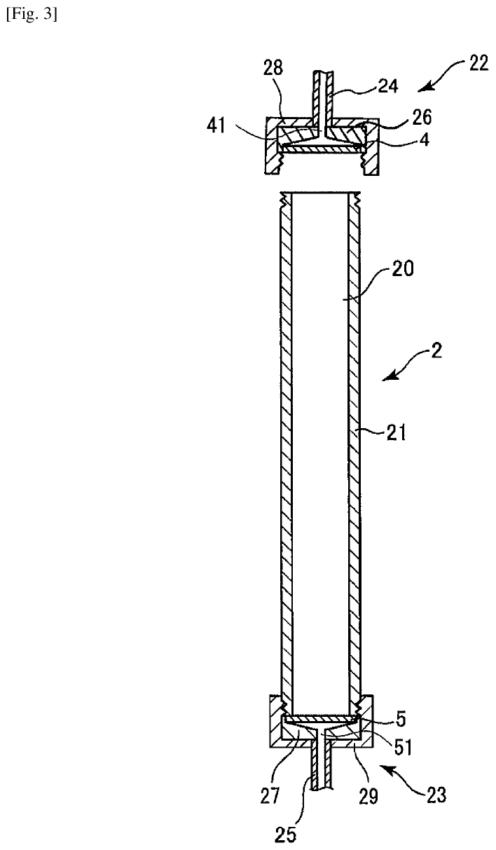

FIG. 2 is a flowchart illustrating the method of manufacturing an adsorption apparatus of an embodiment of the present invention, and FIGS. 3 to 5 are vertical cross-sectional views for explaining the method of manufacturing an adsorption apparatus of an embodiment of the present invention. Note that, in the following description, the upper side in FIGS. 3 to 5 is referred to as “inflow side” or “above” and the lower side is referred to as “outflow side” or “below”.

As illustrated in FIG. 2, the method of manufacturing an adsorption apparatus of an embodiment of the present invention includes a step [S1B] of preparing a column 2; a step [S2B] of preparing an extension column 200, and connecting a column passage section 221 of the extension column 200 to a column main body 21 of the column 2 to obtain a column connection body 250; a step [S3B] of charging a slurry 30 containing a powder of hydroxyapatite constituting an adsorbent 3 and a dispersion in the column connection body 250; a step [S4B] of supplying a filling solution 66 from the extension column 200 side to the column main body 21 side in the column connection body 250 in a state in which the column connection body 250 is disposed such that the extension column 200 is located vertically below; and a step [S5B] of disengaging the extension column 200 from the column connection body 250 to obtain an adsorption apparatus 1.

These steps will be described sequentially below.

### {S1B: Step of Preparing Column 2}

In this step, the column 2 included in the above-described adsorption apparatus 1 is prepared (first step).

In the present embodiment, a column in which, of the cover portions 22 and 23 (ports), the cover portion 23 is attached to the outflow side end of the column main body 21, and the cover portion 22 is not attached to the inflow side end of the column main body 21, as illustrated in FIG. 3, is prepared as the column 2.

### {S2B: Step of Preparing Column Connection Body 250}

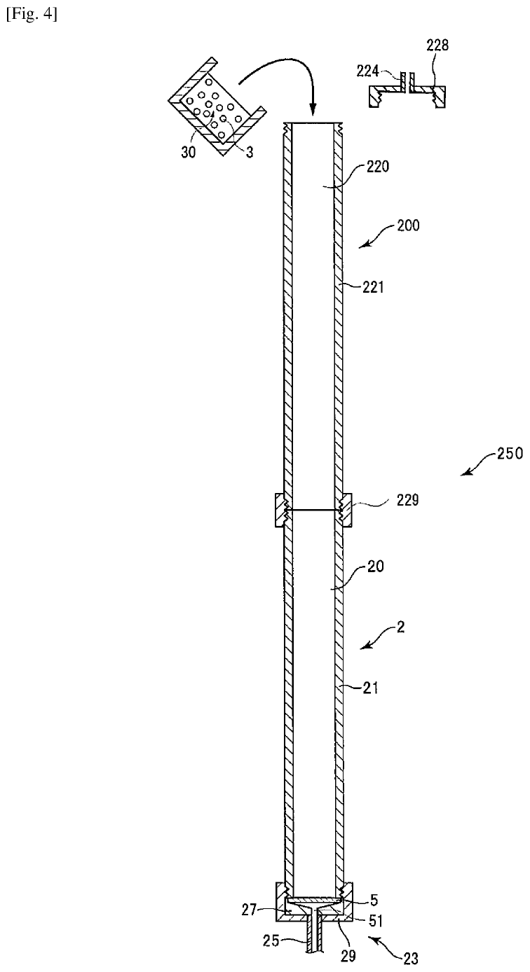

In this step, the extension column 200 is prepared, and the column passage section 221 of the extension column 200 is connected to the column main body 21 of the column 2 to obtain the column connection body 250 (see FIG. 4).

As illustrated in FIG. 4, the extension column 200 includes a column passage section 221, and a cap 228 and a connection section 229, respectively, attached to the inflow side end (one end) and the outflow side end (the other end) of the column passage section 221.

The column passage section 221 is cylindrical, has an adsorbent passage space 220 therein, and is substantially identical, in configuration, to the column main body 21 included in the column 2.

The cap 228 having an inlet pipe 224 (third flow path) at a central portion is attachable to the inflow side end of the column passage section 221 by screwing. However, in this step [S2B], the cap 228 is in an unattached state. Further, the connection section 229 that is connectable to the inflow side end of the column main body 21 is attached to the outflow side end of the column passage section 221 by screwing.

Then, the connection section 229 is attached to the inflow side end of the column main body 21 of the column 2 by screwing, so that the column connection body 250 can be obtained in which the outflow side end of the column passage section 221 included in the extension column 200 is connected to the inflow side end of the column main body 21 included in the column 2 via the connection section 229.

### {S3B: Step of Supplying Slurry 30 to Column Connection Body 250}

In this step, the column connection body 250 is filled with the slurry 30 containing a powder of hydroxyapatite as a powder formed from aggregates of fine particles having a non-constant particle size, which constitutes the adsorbent 3, and a dispersion (first liquid) (second step).

This step includes a step [S3B-1] of preparing the slurry 30 containing a powder of hydroxyapatite constituting the adsorbent 3 and a dispersion (first liquid) and a step [S3B-2] of supplying the slurry 30 to the column connection body 250.

These steps [S3B-1] and [S3B-2] constituting the present step [S3B] will be described sequentially.

### {S3B-1: Step of Preparing Slurry 30 Containing Adsorbent 3 and Dispersion}

In this step, the slurry 30 (composition) in which the adsorbent 3 is dispersed in the dispersion is prepared by stirring the powder (green powder or sintered powder) obtained by the method of manufacturing a powder of hydroxyapatite as the adsorbent 3 in the dispersion (first liquid).

Specifically, for example, a powder of hydroxyapatite is mixed in the dispersion while the dispersion is stirred in a container (not illustrated), and the powder of hydroxyapatite (adsorbent 3) is dispersed in the dispersion by the mixing.

The dispersion (first liquid) for dispersing the powder of hydroxyapatite is water or a solution in which a buffer solution or salt is contained in water. The buffer solution or salt includes, for example, sodium salts, potassium salts, ammonium salts, magnesium salts, calcium salts, chlorides, fluorides, acetates, phosphates, and citrates, and one thereof or a combination of two or more can be used. Among these, a sodium phosphate buffer solution is preferable. By using the sodium phosphate buffer solution as the dispersion, the powder of hydroxyapatite can be stably dispersed in the slurry.

In addition, when the sodium phosphate buffer solution is used, a concentration thereof is not particularly limited, but is preferably set to approximately 0.1 M or greater and 0.6 M or less, and more preferably approximately 0.15 M or greater and 0.4 M or less.

Furthermore, a pH of the sodium phosphate buffer solution is preferably approximately 6.0 or greater and 9.0 or less, and more preferably approximately 6.8 or greater and 9.0 or less.

Furthermore, a liquid temperature (temperature) of the dispersion is not particularly limited, but is preferably set to approximately 0° C. or higher and 70° C. or lower, and more preferably approximately 25° C. or higher and 50° C. or lower.

{S3B-2: Step of supplying slurry 30 to column connection body 250}

In this step, the slurry 30 prepared in the step [S3B-1] is supplied to column connection body 250.

Specifically, as shown in FIG. 4, in the column connection body 250 in which the column main body 21 of the column 2 and the column passage section 221 of the extension column 200 are connected to each other, the column main body 21 of the column 2 is located vertically below, and the column passage section 221 of the extension column 200 is located vertically above.

The slurry 30 in which the adsorbent 3 is dispersed is supplied to the adsorbent passage space 220 included in the column passage section 221 of the extension column 200, from an opening that opens at the inflow side end (upper end) of the column passage section 221.

In this way, the slurry 30 containing the adsorbent 3 to be charged in the adsorbent filling space 20 included in the column main body 21 of the column 2 can be charged in the adsorbent passage space 220 included in the column passage section 221 of the column connection body 250 to which the column main body 21 is connected. Note that the adsorbent 3 charged in the adsorbent passage space 220 of the column passage section 221 may drop inside the adsorbent passage space 220 due to its own weight, and a portion thereof may be moved to the adsorbent filling space 20 of the column main body 21.

### {S4B: Step of Supplying Filling Solution 66 to Column Connection Body 250}

In this step, the filling solution 66 (second liquid) is supplied to the column connection body 250 from the extension column 200 side in a state in which the column connection body 250 is disposed such that the extension column 200 is located vertically below (third step).

This step has a step [S4B-1] in which the column connection body 250 is disposed such that the extension column 200 is located vertically below and [S4B-2] in which the filling solution 66 (second liquid) is supplied to the column 2 (column main body 21) side from the extension column 200 side in the column connection body 250.

These steps [S4B-1] and [S4B-2] constituting the present step [S4B] will be described sequentially.

{S4B-1: Step of Disposing Column Connection Body 250 with Extension Column 200 Side being Located Vertically Below}

In this step, the column connection body 250 in which the slurry 30 is charged in the adsorbent passage space 220 included in the column passage section 221 of the extension column 200 is disposed such that the extension column 200 side is located vertically below.

Specifically, the cap 228 is attached, by screwing, to the inflow side end (upper end) of the column passage section 221 of the extension column 200, in the column connection body 250 in which the slurry 30 is charged in the adsorbent passage space 220 included in the column passage section 221 of the extension column 200.

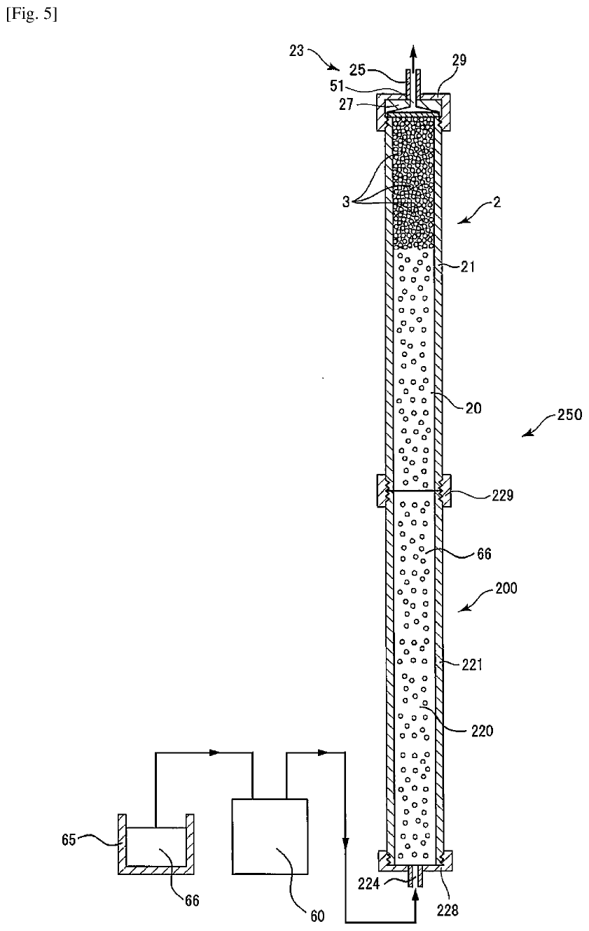

Specifically, as shown in FIG. 5, the column connection body 250 in which the column main body 21 of the column 2 and the column passage section 221 of the extension column 200 are connected to each other is disposed such that the column main body 21 of the column 2 is located vertically above, and the column passage section 221 of the extension column 200 is located vertically below. That is, in the column connection body 250 in which the column 2 and the extension column 200 are connected to each other, the column connection body 250 is disposed such that the inflow side end of the column connection body 250 is located vertically below, and the outflow side end of the column connection body 250 is located vertically above.

Note that, when the column connection body 250 is disposed in such a manner, the filling solution 66 (second liquid) may not be supplied to the adsorbent passage space 220 of the column passage section 221 via the inlet pipe 224 of the cap 228, but it is preferable to supply the filling solution 66 to the adsorbent passage space 220 in advance. As a result, as illustrated in FIGS. 4 through 5, when the column connection body 250 is inverted such that the extension column 200 is changed to be located vertically below from the state in which it is located vertically above, the adsorbent 3 charged in the adsorbent passage space 220 can be securely suppressed or prevented from unintentionally flowing down toward the inflow side end side of the column passage section 221, that is, toward the cap 228 side.

In a case where the filling solution 66 is supplied in advance to the adsorbent passage space 220, the filling solution 66 is started to be supplied to the adsorbent passage space 220 of the column passage section 221 via the inlet pipe 224 of the cap 228, in a state in which the column connection body 250 is disposed such that the column main body 21 of the column 2 is located vertically below and that the column passage section 221 of the extension column 200 is located vertically above. Then, the column connection body 250 is preferably inverted such that the column main body 21 of the column 2 is located vertically above, and that the column passage section 221 of the extension column 200 is located vertically below, at a time point when the filling solution 66 is supplied into a substantially full volume of the adsorbent passage space 220 of the column passage section 221 and the adsorbent filling space 20 of the column main body 21. As a result, the adsorbent 3 charged in the adsorbent passage space 220 can be securely suppressed or prevented from unintentionally flowing down toward the inflow side end side of the column passage section 221.

{S4B-2: Step of Supplying Filling Solution 66 to Column Connection Body 250 from Extension Column 200 Side}

In this step, the filling solution 66 (second liquid) is supplied from the column passage section 221 side of the extension column 200 to the column main body 21 side of the column 2 in the column connection body 250. That is, the filling solution 66 (second liquid) is supplied from the inflow side end side to the outflow side end side of the column connection body 250.

Specifically, for example, as shown in FIG. 5, in a state in which the column connection body 250 is disposed such that the column main body 21 of the column 2 is located vertically above and that the column passage section 221 of the extension column 200 is located vertically below, the filling solution 66 stored in a container 65 is supplied using a pump 60 to the adsorbent passage space 220 of the column passage section 221 via the inlet pipe 224 (third flow path) of the cap 228.

Due to the supply of the filling solution 66 to the adsorbent passage space 220 of the column passage section 221, the filling solution 66 is charged in the adsorbent passage space 220 of the column passage section 221 and the adsorbent filling space 20 of the column main body 21 until the spaces are substantially fully filled with the filling solution 66, and then is discharged from the outlet pipe 25 of the cover portion 23. That is, the driving force of the pump 60 causes the filling solution 66 to flow and pass through the adsorbent passage space 220 of the column passage section 221 as upstream and the adsorbent filling space 20 of the column main body 21 as downstream in the column connection body 250.

Due to the passage of the filling solution 66 through the adsorbent passage space 220 as upstream and the adsorbent filling space 20 as downstream in the adsorbent passage space 220 of the column passage section 221 and the adsorbent filling space 20 of the column main body 21, that is, the passage of the filling solution 66 from below toward above in the column connection body 250, the adsorbent 3 contained in the slurry sequentially ascends in the adsorbent passage space 220 included in the column passage section 221 and the adsorbent filling space 20 included in the column main body 21, and thus is charged in the adsorbent filling space 20 of the column main body 21.

When the adsorbent 3 ascends in the adsorbent passage space 220 and the adsorbent filling space 20, a descending force due to gravity exerted on the adsorbent 3 acts on the adsorbent 3, in addition to an ascending force applied by the passing filling solution 66.

Here, the adsorbent 3, i.e., the powder of hydroxyapatite contains secondary particles obtained by granulating primary particles and agglomerates thereof, and therefore has a relatively large particle size distribution. Therefore, the powder of hydroxyapatite can be said to be a powder formed from aggregates of fine particles having a non-constant particle size.

Thus, even when the adsorbent 3 has a relatively large particle size distribution, both the ascending force due to the filling solution 66 passing through the adsorbent passage space 220 and the adsorbent filling space 20, and the descending force due to gravity act on the adsorbent 3 when the adsorbent 3 is charged in the adsorbent filling space 20 included in the column main body 21. Therefore, the adsorbent 3 ascends in the adsorbent passage space 220 and the adsorbent filling space 20 while convecting within the adsorbent passage space 220 and the adsorbent filling space 20, and is charged in the adsorbent filling space 20. Therefore, the adsorbent 3 is charged in the adsorbent filling space 20 in a manner that the adsorbent 3 with a large particle size is suppressed or prevented from being unevenly distributed on a lower side of the adsorbent filling space 20, and the adsorbent 3 with a small particle size is suppressed or prevented from being unevenly distributed on an upper side of the adsorbent filling space 20. Therefore, the adsorbent 3 is charged in the adsorbent filling space 20 in a manner that non-uniformity in particle size distribution of the adsorbent 3 in the adsorbent filling space 20 (column 2) is securely suppressed or prevented. Thus, since non-uniformity in particle size distribution is securely suppressed or prevented, the column performance of purifying and isolating the biopharmaceuticals, i.e., substances to be adsorbed can be reliably imparted to the adsorption apparatus 1 that includes the adsorbent 3. Furthermore, excellent durability can be imparted to the adsorbent 3 included in the column 2.

Due to the supply of the filling solution 66 to the column connection body 250, the adsorbent 3 is charged in the adsorbent filling space 20 while non-uniformity in particle size distribution is securely suppressed or prevented, i.e., charged in the adsorbent filling space 20 with a substantially uniform particle size distribution. Specifically, in the present invention, a degree of the particle size distribution of the adsorbent satisfies the relationship 0.72≤A1/A3≤1.38, when a region at the inflow side end (one end) of the adsorbent filling space 20 is a first region a1, a region at a central portion (midpoint) between the inflow side end and the outflow side end is a second region a2, and a region at the outflow side end (the other end) is a third region a3, as illustrated in FIG. 1, and when a modal particle size in a particle size distribution of the adsorbent 3 present in the first region a1 is A1 [μm], and a modal particle size in a particle size distribution of the adsorbent 3 present in the third region a3 is A3 [μm]. As described above, A1/A3, as a parameter representing the uniformity of the modal particle sizes A1 and A3 of the adsorbents 3 present in the first region a1 and the third region a3, which are both ends of the adsorbent filling space 20, satisfies the relationship 0.72≤A1/A3≤1.38. Therefore, it can be said that the adsorbent 3 is charged in the adsorbent filling space 20 with a substantially uniform particle size distribution, and the column performance of purifying and isolating the biopharmaceuticals, i.e., substances to be adsorbed can be reliably imparted to the adsorption apparatus 1 that includes the adsorbent 3. That is, the adsorption apparatus 1 that includes the adsorbent 3 can have improved separation performance. Furthermore, excellent durability can be imparted to the adsorbent 3 included in the column 2. Furthermore, the A1/A3 preferably satisfies the relationship 0.85≤A1/A3≤1.20. The A1/A3 more preferably satisfies the relationship 0.90≤A1/A3≤1.10. As a result, the effect can be more significantly exhibited. In other words, a lower limit value of the A1/A3 is 0.72, more preferably 0.85, and further preferably 0.90. Furthermore, an upper limit value of the A1/A3 is 1.38, more preferably 1.20, and further preferably 1.10.

In addition, as for the relationship between the modal particle sizes A1 and A3 of the adsorbents 3 present in the first region a1 and the third region a3, |A1-A3| as another parameter representing the uniformity of the adsorbents 3 present in the first region a1 and the third region a3 preferably satisfies the relationship of |A1-A3| 10 μm, and more preferably satisfies the relationship 0.1 m μ|A1-A3| 4.0 m, in addition to the above relationship of the A1/A3. Also from the fact that the modal particle sizes A1 and A3 satisfy the relationship, it can be said that the adsorbent 3 is charged in the adsorbent filling space 20 with a substantially uniform particle size distribution, and the column performance of purifying and isolating the biopharmaceuticals, i.e., substances to be adsorbed can be reliably imparted to the adsorption apparatus 1 that includes the adsorbent 3. Furthermore, excellent durability can be imparted to the adsorbent 3 included in the column 2. In other words, a lower limit value of the |A1-A3| is more preferably 0.1 μm. Furthermore, an upper limit value of |A1-A3| is preferably 10 μm, and more preferably 4.0 μm.

Furthermore, when a frequency of the modal particle size A1 in the particle size distribution of the adsorbent 3 present in the first region a1 is B1(%), and a frequency of the modal particle size A3 in the particle size distribution of the adsorbent 3 present in the third region a3 is B3(%), the B1/B3 preferably satisfies 0.9≤B1/B3≤1.1, and more preferably satisfies 0.95≤B1/B3≤1.05. In other words, a lower limit value of the B1/B3 is preferably 0.9, and more preferably 0.95. Furthermore, an upper limit value of the B1/B3 is preferably 1.1, and more preferably 1.05.

In addition, as for the relationship between the frequencies B1 and B3 of the modal particle sizes A1 and A3 of the adsorbents 3 present in the first region a1 and the third region a3, |B1-B3| as another parameter representing the uniformity of the adsorbents 3 present in the first region a1 and the third region a3 preferably satisfies the relationship of |B1-B3|≤3.0%, and more preferably satisfies the relationship 0.5%|B1-B3|≤3.0%, in addition to the above relationship of the B1/B3. In other words, a lower limit value of the |B1-B3| is more preferably 0.5%. Moreover, an upper limit value of the |B1-B3| is preferably 3.0%.

From the fact that the frequencies B1 and B3 of the modal particle sizes A1 and A3 of the adsorbents 3 present in the first region a1 and the third region a3 satisfy the relationship described above, it can be said that the adsorbent 3 is charged in the adsorbent filling space 20 with a more uniform particle size distribution, and the effect can be more significantly exhibited.

Furthermore, in addition to the relationships of the modal particle sizes A1 and A3 of the adsorbents 3 present in the first region a1 and the third region a3, when a modal particle size in a particle size distribution of the adsorbent 3 present in the second region a2 is A2 [μm], the relationship between the modal particle sizes A1 and A2 preferably satisfies the relationship 0.72≤A1/A2≤1.38. The A1/A2 is more preferably 0.85≤A1/A2≤1.2, further preferably 0.90≤A1/A2≤1.1, and most preferably 0.95≤A1/A2≤1.05. In other words, a lower limit value of the A1/A2 is preferably 0.72, more preferably 0.85, further preferably 0.90, and most preferably 0.95. In addition, an upper limit value of the A1/A2 is preferably 1.38, more preferably 1.2, further preferably 1.1, and most preferably 1.05.

In addition, as for the relationship between the modal particle sizes A1 and A2 of the adsorbents 3 present in the first region a1 and the second region a2, |A1-A2| as another parameter representing the uniformity of the adsorbents 3 present in the first region a1 and the second region a2 preferably satisfies the relationship of |A1-A2|≤10 μm, and more preferably satisfies the relationship 0.1 μm |A1-A2| 4.0 μm, in addition to the above relationship of the A1/A2. In other words, the lower limit value of the |A1-A2| is more preferably 0.1 μm. Furthermore, the upper limit value of the |A1-A2| is preferably 10 μm, and more preferably 4.0 μm.

From the fact that the modal particle sizes A1 and A2 of the adsorbents 3 present in the first region a1 and the second region a2 satisfy the relationship described above, it can be said that the adsorbent 3 is charged in the adsorbent filling space 20 with a more uniform particle size distribution, and the effect can be more significantly exhibited.

Furthermore, when a frequency of the modal particle size A2 in the particle size distribution of the adsorbent 3 present in the second region a2 is B2(%), B1/B2 preferably satisfies 0.80≤B1/B2≤1.15, more preferably satisfies 0.85≤B1/B2≤1.10, further preferably satisfies 0.90≤B1/B2≤1.05, and even more preferably satisfies 0.95≤B1/B2≤1.02, in addition to the relationship between the frequencies B1 and B3 of the modal particle sizes A1 and A3 of the adsorbents 3 present in the first region a1 and the third region a3. In other words, a lower limit value of the B1/B2 is preferably 0.80, more preferably 0.85, further preferably 0.90, and even more preferably 0.95. An upper limit value of the B1/B2 is preferably 1.15, more preferably 1.10, further preferably 1.05, and even more preferably 1.02.

In addition, as for the relationship between the frequencies B1 and B2 of the modal particle sizes A1 and A2 of the adsorbents 3 present in the first region a1 and the second region a2, |B1-B2| as another parameter representing the uniformity of the adsorbents 3 present in the first region a1 and the second region a2 preferably satisfies the relationship of |B1-B2|≤3.0%, and more preferably satisfies the relationship 0.5%≤|B1-B2|≤3.0%, in addition to the above relationship of the B1/B2. In other words, a lower limit value of the |B1-B3| is more preferably 0.5%. Moreover, an upper limit value of the |B1-B3| is preferably 3.0%.

From the fact that the frequencies B1 and B2 of the modal particle sizes A1 and A2 of the adsorbents 3 present in the first region a1 and the second region a2 satisfy the relationship described above, it can be said that the adsorbent 3 is charged in the adsorbent filling space 20 with a more uniform particle size distribution, and the effect can be more significantly exhibited.

When median particle sizes of the adsorbents 3 present in the first regions a1, the second regions a2, and the third regions a3 are C1, C2, and C3, respectively, C1/C3 preferably satisfies a formula 0.7≤C1/C3≤1.3. The value more preferably satisfies a formula 0.8≤C1/C3≤1.2, and further preferably satisfies a formula 0.9≤C1/C3≤1.1.

Furthermore, when the median particle sizes of the adsorbents 3 present in the first regions a1, the second regions a2, and the third regions a3 are C1, C2, and C3, respectively, C1, C2, and C3 preferably satisfy 0.9≤C1/C3≤1.1 and 0.9≤C1/C2≤1.1, and more preferably satisfy 0.95≤C1/C2≤1.05 and 0.95≤C1/C2≤1.05.

Also, when average particle sizes of the adsorbents 3 present in the first regions a1, the second regions a2, and the third regions a3 are D1, D2, and D3, respectively, D1, D2, and D3 preferably satisfy 0.9≤D1/D3≤1.1 and 0.9≤D1/D2≤1.1, and more preferably satisfy 0.95≤D1/D3≤1.05 and 0.95≤D1/D2≤1.05.

Also, when standard deviations of the particle sizes of the adsorbents 3 present in the first regions a1, the second regions a2, and the third regions a3 are E1, E2, and E3, respectively, E1, E2, and E3 preferably satisfy 0.9≤E1/E3≤1.1 and 0.9≤E1/E2≤1.1, and more preferably satisfy 0.95≤E1/E3≤1.05 and 0.95≤E1/E2≤1.05.

Also, when widths of the particle sizes of the adsorbents 3 present in the first regions a1, the second regions a2, and the third regions a3 are F1, F2, and F3, respectively, F1, F2, and F3 preferably satisfy 0.9≤F1/F3≤1.1 and 0.9≤F1/F2≤1.1, and more preferably satisfy 0.95≤F1/F3≤1.05 and 0.95≤F1/F2≤1.05.

As described above, from the fact that not only the modal particle sizes of the adsorbents 3 present in the first region a1, the second region a2, and the third region a3, but also the median particle sizes, the average particle sizes, the standard deviations of the particle size, and the widths of the particle size of the adsorbent 3 satisfy the relationships described above, it can be said that non-uniformity in particle size distribution of the adsorbent 3 charged in the adsorbent filling space 20 (column 2) can be securely suppressed or prevented. Thus, the effect can be more significantly exhibited by satisfying the above-described relationships.

Examples of the filling solution 66 (second liquid) supplied to the column connection body 250 are the same as those of the dispersion contained in the slurry 30 described above. Especially, water is preferable. Water is preferably used as the filling solution 66 supplied, in a large amount, to the column connection body 250 using the pump 60 because water is easier to handle than a buffer solution or the like.

A liquid temperature (temperature) of the filling solution 66 is not particularly limited, but is preferably set to approximately 0° C. or higher and 70° C. or lower, and more preferably approximately 25° C. or higher and 50° C. or lower.

Furthermore, a flow rate when supplying the filling solution 66 to the column connection body 250 is not particularly limited, but is preferably set to approximately 70 mL/min or greater, more preferably approximately 100 mL/min or greater and 250 mL/min or less, and further preferably approximately 110 mL/min or greater and 180 mL/min or less.

In addition, a time for supplying the filling solution 66 to the column connection body 250 is not particularly limited, but is preferably set to approximately 5 min or longer, and more preferably approximately 20 min or longer and 60 min or shorter.

By setting the conditions for supplying the filling solution 66 to the column connection body 250 as described above, the adsorbent 3 can be charged in the adsorbent filling space 20 of the column main body 21 where the dimensions of the adsorbent filling space 20 are set as described above, while non-uniformity in particle size distribution is securely suppressed or prevented. In other words, the A1/A3, which is the parameter representing the uniformity of the modal particle sizes A1 and A3 of the adsorbent 3, reliably satisfies the relationship 0.72≤A1/A3≤1.38, and the adsorbent 3 can be charged in the adsorbent filling space 20.

### {S5B: Step of Disengaging Extension Column 200}

In this step, the adsorption apparatus 1 is obtained by disengaging the extension column 200 from the column connection body 250.

Specifically, the connection section 229, which is attached to the inflow side end of the column main body 21 of the column 2 by screwing, is disengaged from the column main body 21. As a result, the extension column 200 is disengaged from the column 2 in the column connection body 250.

The cover portion 22 is then attached to the inflow side end of the column main body 21 of the column 2 from which the connection section 229 has been disengaged, by screwing the cap 28 onto the inflow side end of the column main body 21. As a result, the adsorption apparatus 1 can be obtained in which the adsorbent 3 is charged in the adsorbent filling space 20 of the column main body 21, and the liquid tightness of the adsorbent filling space 20 is ensured by the column main body 21 and the cover portions 22 and 23.

The adsorption apparatus 1 is manufactured through the steps [S1B] to [S5B] as described above.

In addition, in the present embodiment, a case has been described in which the adsorbent 3 is charged in the adsorbent filling space 20 of the column main body 21 as the column connection body 250 in which the extension column 200 is connected to the column 2. However, for example, if the pump 60 is used to supply a product containing the adsorbent 3 as the filling solution 66 to the adsorbent filling space 20 of the column main body 21, the connection of the extension column 200 to the column 2 can be omitted.

In this case, the steps [S2B] and [S3B] may be omitted, and, in the above step [S4B], the filling solution 66 containing the adsorbent 3 may be supplied to the adsorbent filling space 20 of the column main body 21 via the inlet pipe 24 of the cover portion 22 in a state in which the column 2, in which the cover portions 22 and 23 are attached to the column main body 21, is disposed such that the cover portion 22 side is located vertically below.

In addition, in the present embodiment, in the column 2, the cover portion 22 side is defined as the inflow side where the liquid flows into the adsorbent filling space 20, and the cover portion 23 side is defined as the outflow side where the liquid flows out of the adsorbent filling space 20. However, the relationship between these sides can be inverted such that the liquid flows in from the cover portion 23 side, and that the liquid flows out from the cover portion 22 side via the adsorbent filling space 20.

In another preferred embodiment of the present invention, instead of charging the adsorbent 3 in the adsorbent filling space 20 as in the above steps [S1B] to [S5B], the adsorbent 3 may be charged in the adsorbent filling space 20 in a zero gravity environment. Since heavy particles do not precipitate under zero gravity, it is possible to securely suppress or prevent non-uniformity in particle size distribution of the powder in the column without necessarily performing the above steps [SIB] to [S5B]. Alternatively, when the adsorbent 3 is charged in the adsorbent filling space 20, precipitation of heavy particles can be prevented or suppressed by using a filling solution having a very high viscosity.

The adsorption apparatus of an embodiment of the present invention and the method of manufacturing an adsorption apparatus of an embodiment of the present invention have been described above, but the present invention is not limited thereto.

For example, in the adsorption apparatus of an embodiment of the present invention, each of the configurations can be substituted by any configuration that can perform a similar function, or can be added with any configuration. In addition, in the method of manufacturing an adsorption apparatus of an embodiment of the present invention, one or greater steps can be added for any purpose.

Further, in the above-described embodiment, a case has been described in which the column main body included in the column and the column passage section included in the extension column are each cylindrical. However, the column main body and the column passage section may be tubular, and may have a polygonal tubular shape such as a hexagonal or heptagonal shape.

### EXAMPLE

Next, specific examples of the present invention will be described.

Note that the present invention is not limited to the description of these examples.

### 1. Discussion of Charging of Adsorbent in Column

### Reference Example 1

[R1-1] First, a column 2 including a column main body 21 having a column inner diameter φ of 50 mm×a column length of 230 mm and an extension column 200 including a column passage section 221 having a column inner diameter φ of 50 mm×a column length of 230 mm were prepared. A column connection body 250 was obtained by attaching a connection section 229 of the extension column 200 to an inflow side end of the column main body 21 of the column 2 by screwing.

[R1-2]A slurry 30 was prepared by weighing 248 g of a sintered powder of hydroxyapatite (CHT 40 μm Type I, available from Bio-Rad Laboratories) as an adsorbent 3, and dispersing while stirring the adsorbent 3 in 737 mL of a 0.2 mM sodium phosphate buffer solution at 25° C.

[R1-3] The column connection body 250 was then disposed such that column 2 was located vertically below, and that the extension column 200 was located vertically above, as shown in FIG. 4. Thereafter, the slurry 30 was supplied to an adsorbent passage space 220 included in the column passage section 221 from an opening that opened at an upper end of the column passage section 221 included in the extension column 200, so that the slurry 30 was charged in the adsorbent passage space 220. A cap 228 was then attached to the upper end of the column passage section 221 by screwing.

[R1-4] Next, by inverting the column connection body 250 a plurality of times in the vertical direction while stirring, the adsorbent 3 precipitated by gravity was suspended. At the same time when the column connection body 250 was maintained such that the column 2 was located vertically above and the extension column 200 was located vertically below, the supply of water as a filling solution 66 contained in a container 65 to the adsorbent passage space 220 of the column passage section 221 via an inlet pipe 224 of the cap 228 was started using a pump 60.

At this time, a flow rate of water to the adsorbent passage space 220 of the column passage section 221 using the pump 60 was set to 160 mL/min.

Then, the supply of water to the adsorbent passage space 220 at a flow rate of 160 mL/min was continuously performed for 30 minutes. At this time, a thickness of the adsorbent 3 charged in the adsorbent passage space 220 from the inflow side end to an outflow side end of the column main body 21 was measured.

### Reference Examples 2 and 3

In the above step [R1-4], the thickness of the adsorbent 3 charged in the adsorbent passage space 220 from the inflow side end toward the outflow side end of the column main body 21 was measured in the same manner as in Reference Example 1, except that the flow rate of water and a supply time of water, when water was supplied to the adsorbent passage space 220 of the column passage section 221 using the pump 60, were changed as shown in Table 1.

The results of the thickness of the adsorbent 3 charged in the adsorbent passage space 220 measured in Reference Examples 1 to 3 are shown in Table 1.

TABLE 1

| | Refer- | | | | | | Refer- |
|---|---|---|---|---|---|---|---|
| | ence | | | | | | ence |
| | Exam- | | | | | | Exam- |
| | ple 1 | Reference Example 2 | | | | | ple 3 |
| Flow rate [mL/ | 160 | 120 | | | | | 80 |
| min] of water | | | | | | | |
| supplied to | | | | | | | |
| column 2 | | | | | | | |
| Supply time [min] | 30 | 33 | 56 | 65 | 79 | 94 | 50 |
| of water to | | | | | | | |
| column 2 | | | | | | | |
| Thickness of | 203 | 191 | 193 | 193 | 194 | 195 | 180 |
| adsorbent 3 | | | | | | | |

As is clear from Table 1, by setting the flow rate to 80 mL/min or greater for the column main body 21 with the column inner diameter φ of 50 mm, the adsorbent 3 can be charged when the extension column 200 includes the adsorbent passage space 220 having a column length of approximately 180 mm or less. It was revealed to be enough to set the flow rate of water as appropriate in accordance with the column inner diameter, column length, filling time, and the like (for example, sufficient to set the flow rate of the water to 160 mL/min, when the column length was approximately 200 mm).

### 2. Discussion of Particle Size Distribution of Adsorbent in Each Region of Adsorption Apparatus

### 2-1. Manufacture of Adsorption Apparatus

### Example 1

[E1-1] First, the column connection body 250 was obtained in the same manner as in the above step [R1-1].

[E1-2] The slurry 30 was then prepared in the same manner as in the above step [R1-2].

[E1-3] Next, the cap 228 was attached on the upper end of the column passage section 221 after the slurry 30 was charged in the adsorbent passage space 220 in the same manner as in the above step [R1-3].

[E1-4] Next, in the same manner as in the above step [R1-4], by inverting the column connection body 250 a plurality of times in the vertical direction while stirring, the adsorbent 3 precipitated by gravity was suspended. At the same time when the column connection body 250 was maintained such that the column 2 was located vertically above and the extension column 200 was located vertically below, the supply of water as a filling solution 66 contained in a container 65 to the adsorbent passage space 220 of the column passage section 221 via an inlet pipe 224 of the cap 228 was started using a pump 60.

At this time, a flow rate of water to the adsorbent passage space 220 of the column passage section 221 using the pump 60 was set to 160 mL/min.

[E1-5] Next, the supply of water to the adsorbent passage space 220 of the column passage section 221 using the pump 60 was continued until the adsorbent 3 ascended sequentially in the adsorbent passage space 220 included in the column passage section 221 and the adsorbent filling space 20 included in the column main body 21, and the adsorbent 3 was substantially fully charged in the adsorbent filling space 20 included in the column main body 21. The column was then returned to its original state, and the adsorbent was fully charged therein.

[E1-6] The operation of the pump 60 was then stopped, thereby terminating the supply of water to the adsorbent passage space 220 of the column passage section 221. Then, the extension column 200 was disengaged from the column 2 due to disengagement, from the column main body 21, of the connection section 229, which was attached, by screwing, to the inflow side end of the column main body 21 of the column 2. Then, the cover portion 22 was attached to the inflow side end of the column main body 21 where the connection section 229 was disengaged by screwing the cap 28 onto the inflow side end of the column main body 21, so that an adsorption apparatus 1 of Example 1 was obtained.

### Comparative Example 1

In the above step [E1-4] and the step [E1-5], the adsorption apparatus 1 of Comparative Example 1 was obtained in the same manner as in Example 1, except that, without the inversion of the column connection body 250 such that the column 2 was located vertically above and that the extension column 200 was located vertically below, water was supplied to the adsorbent passage space 220 of the column passage section 221 using the pump 60.

### 2-2. Measurement of Particle Size Distribution of Adsorbent in Each Region of Column Included in Adsorption Apparatus

For the adsorption apparatus of Example 1 and the adsorption apparatus of Comparative Example 1, the column main body 21 was maintained horizontally after the cover portion 22 was disengaged from the column main body 21, and water was supplied from the cover portion 23 with the pump 60 to take the adsorbent 3 charged in the adsorbent filling space 20 out of the column 2.

Thereafter, this adsorbent 3 was collected in an amount of approximately 1 g with a spatula from the center of an end (one end part) serving as a first region a1 on the inlet pipe 24 side of the column main body 21, in an amount of approximately 1 g with a spatula from the center of a center portion (midpoint) serving as a second region a2, and in an amount of approximately 1 g with a spatula from the center of an end (the other end) serving as a third region a3 on the outlet pipe 25 side of the column main body 21, separately in a container containing water.

Then, for the adsorbents 3 that were present at positions corresponding to the regions (first region a1, second region a2, and third region a3), the particle size distribution of the adsorbent 3 was measured using MT3300EX2 (available from MicrotracBEL Corp.) under conditions: number of measurements: 2 times, measurement time: 30 seconds, distribution display: volume, particle refractive index: 1.65, solvent: water, and solvent refractive index: 1.333.

Note that the measurements of the particle size distributions of the adsorbents 3 that were present at positions corresponding to the regions (first region a1, second region a2, and third region a3) in the adsorption apparatuses of Example 1 and Comparative Example 1 were each performed twice repetitively to determine average values from the measurement values for two lots, thereby calculating the particle size distributions of the adsorbents 3.

The results are shown in Table 2.

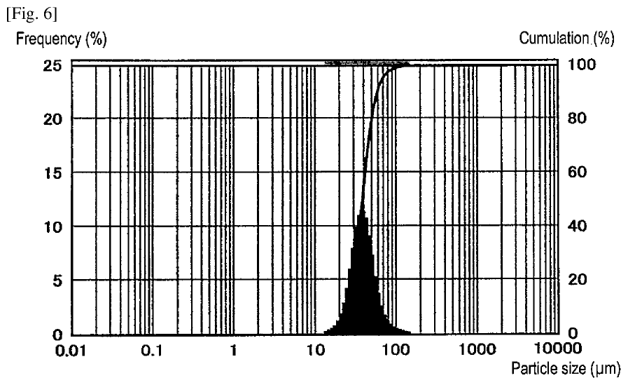

Note that FIG. 6 is a graph showing the particle size distribution of the adsorbent 3 that was present at the position corresponding to the first region a1 in the adsorption apparatus of Example 1.

TABLE 2

| | | | | Compar- |
|---|---|---|---|---|
| | | | | ative |
| | | | Examples | Example |
| | | | 1 | 1 |
| Adsor- | First | Modal particle size A1 [μm] | 40.35 | 31.11 |
| bent 3 | region | Frequency B1 [%] of modal | 11.29 | 13.57 |
| | a1 | particle size A1 | | |
| | | Median particle size C1 [μm] | 38.28 | 29.42 |
| | | Average particle size D1 [μm] | 36.52 | 28.94 |
| | | Standard deviation E1 [μm] of | 12.24 | 7.86 |
| | | particle size | | |
| | | Width F1 [μm] of particle size | 24.48 | 15.72 |
| | Second | Modal particle size A2 [μm] | 40.35 | 44.00 |
| | region | Frequency B2 [%] of modal | 11.30 | 11.30 |
| | a2 | particle size A2 | | |
| | | Median particle size C2 [μm] | 39.41 | 40.46 |
| | | Average particle size D2 [μm] | 37.54 | 38.44 |
| | | Standard deviation E2 [μm] of | 12.68 | 12.89 |
| | | particle size | | |
| | | Width F2 [μm] of particle size | 25.36 | 25.78 |
| | Third | Modal particle size A3 [μm] | 44.00 | 44.00 |
| | region | Frequency B3 [%] of modal | 11.26 | 11.64 |
| | a3 | particle size A3 | | |
| | | Median particle size C3 [μm] | 40.52 | 41.15 |
| | | Average particle size D3 [μm] | 38.51 | 39.08 |
| | | Standard deviation E3 [μm] of | 12.96 | 12.80 |
| | | particle size | | |
| | | Width F3 [μm] of particle size | 25.93 | 25.60 |

| | | | |
|---|---|---|---|
| Param- | A1/A3 | 0.92 | 0.71 |
| eters | \|A1 − A3\| | 3.65 | 12.89 |
| repre- | B1/B3 | 1.00 | 1.17 |
| senting | \|B1 − B3\| | 0.03 | 1.93 |
| unifor- | C1/C3 | 0.94 | 0.71 |
| mity of | D1/D3 | 0.95 | 0.74 |
| adsor- | E1/E3 | 0.94 | 0.61 |
| bent 3 | F1/F3 | 0.94 | 0.61 |
| | A1/A2 | 1.00 | 0.71 |
| | \|A1 − A2\| | 0.00 | 12.89 |
| | B1/B2 | 1.00 | 1.20 |
| | \|B1 − B2\| | 0.01 | 2.27 |
| | C1/C2 | 0.97 | 0.73 |
| | D1/D2 | 0.97 | 0.75 |
| | E1/E2 | 0.97 | 0.61 |
| | F1/F2 | 0.97 | 0.61 |

As is clear from Table 2, in the adsorption apparatus of Example 1, in the above steps [E1-4] and the above step [E1-5], the column connection body 250 was disposed such that the column 2 was located vertically above, and the extension column 200 was located vertically below, and water was supplied to the adsorbent passage space 220 of the column passage section 221 using the pump 60 to fill the adsorbent filling space 20 with the adsorbent 3; and thus the result was presented that the relationship 0.72≤A1/A3≤1.38 was satisfied, when the modal particle size in the particle size distribution of the adsorbent 3 present in the first region a1 was A1 [μm], and the modal particle size in the particle size distribution of the adsorbent 3 present in the third region a3 was A3 [μm]. That is, an adsorption apparatus in which non-uniformity in particle size distribution of the adsorbent 3 in the column 2 was securely suppressed could be obtained in Example 1.

In contrast, in the adsorption apparatus of Comparative Example 1, in the above described step [E1-4] and the above step [E1-5], the inversion of the column connection body 250 such that the column connection body 250 was disposed such that the column 2 was located vertically above and the extension column 200 was located vertically below was omitted, and water was supplied to the adsorbent passage space 220 of the column passage section 221 using the pump 60 to fill the adsorbent filling space 20 with the adsorbent 3; and thus the result was presented that the relationship 0.72≤A1/A3≤1.38 could not be satisfied. In other words, the adsorption apparatus obtained in Comparative Example 1 exhibited results that could not suppress nonuniformity in particle size distribution of the adsorbent 3 in the column 2.

Furthermore, when purification and isolation of bovine serum albumin were performed using the adsorption apparatuses of Example 1 and Comparative Example 1, the following result was presented: the adsorption apparatus of Example 1 could perform repeated purification and isolation with excellent accuracy and over a plurality of times, as compared with the adsorption apparatus of Comparative Example 1, i.e., the adsorption apparatus of Example 1 had improved separation performance as compared with the adsorption apparatus of Comparative Example 1.

### REFERENCE SIGNS LIST

1 Adsorption apparatus
2 Column
3 Adsorbent
4 Filter member
5 Filter member
20 Adsorbent filling space
21 Column main body
22 Cover portion
23 Cover portion
24 Inlet pipe
25 Outlet pipe
26 Lid
27 Lid
28 Cap
29 Cap
30 slurry
41 Flow path
51 Flow path
60 Pump
65 Container
66 Filling solution
200 Extension column
220 Adsorbent passage space
221 Column passage section
224 Inlet pipe
228 Cap
229 Connection section
250 Column connection body
a1 First region
a2 Second region
a3 Third region

1. An adsorption apparatus comprising:
a column main body that is tubular and comprises an adsorbent filling space therein;
a first port provided at one end of the column main body and having a first flow path through which liquid flows;
a second port provided at the other end of the column main body and having a second flow path through which liquid flows; and
an adsorbent that is charged in the adsorbent filling space,
wherein
the adsorbent comprises a powder formed from aggregates of fine particles having a nonconstant particle size, and
0.72≤A1/A3≤1.38 is satisfied, where a modal particle size in a particle size distribution of the powder present in a first region, which is one end of the adsorbent filling space, is A1 [μm], and a modal particle size in a particle size distribution of the powder present in a third region, which is the other end of the adsorbent filling space, is A3 [μm].

2. The adsorption apparatus according to claim 1, wherein the powder adsorbs a substance to be adsorbed when a sample solution containing the substance is supplied to the adsorbent filling space via the first flow path of the first port in a state in which the first port is located vertically above the second port.

3. The adsorption apparatus according to claim 2, wherein 0.72≤A1/A2≤1.38 is satisfied, where a modal particle size in a particle size distribution of the powder in a second region located at a midpoint between the one end and the other end is A2 [μm].

4. The adsorption apparatus according to claim 3, wherein 0.80≤B1/B2≤1.15 is satisfied, where a frequency of the modal particle size in the particle size distribution of the powder in the first region is B1(%), and a frequency of the modal particle size in the particle size distribution of the powder in the second region is B2(%).

5. A method of manufacturing an adsorption apparatus, comprising:
a first step of preparing a column comprising: a column main body that is tubular and has an adsorbent filling space therein; a first port provided at one end of the column main body and having a first flow path through which liquid flows; and a second port provided at the other end of the column main body and having a second flow path through which liquid flows;
a second step of charging a composition comprising an adsorbent containing a powder formed from aggregates of fine particles having a non-constant particle size and a first liquid into the adsorbent filling space of the column; and
a third step of supplying a second liquid to the adsorbent filling space via the first flow path of the first port in a state in which the first port side of the column is located vertically below.

6. The method of manufacturing an adsorption apparatus according to claim 5, further comprising, prior to the second step:
a step of preparing an extension column comprising: a column passage section that is tubular and has an adsorbent passage space therein; a cover body provided at one end of the column passage section and having a third flow path through which liquid flows; and a connection section provided at the other end of the column passage section and connectable to the one end side of the column main body; and
a step of connecting, via the connection section, the other end of the column passage section to the one end of the column main body in a state in which the first port is disengaged.

7. The method of manufacturing an adsorption apparatus according to claim 5, wherein the adsorption apparatus obtained through the third step satisfies 0.72≤A1/A3≤1.38, where a modal particle size in a particle size distribution of the powder present in a region at one end of the adsorbent filling space is A1 [μm], and a modal particle size in a particle size distribution of the powder present in a region at the other end of the adsorbent filling space is A3 [μm].

8. The method of manufacturing an adsorption apparatus according to claim 6, wherein the adsorption apparatus obtained through the third step satisfies 0.72≤A1/A3≤1.38, where a modal particle size in a particle size distribution of the powder present in a region at one end of the adsorbent filling space is A1 [μm], and a modal particle size in a particle size distribution of the powder present in a region at the other end of the adsorbent filling space is A3 [μm].
